(19) United States
(12) Patent Application Publication
(10) Pub. No.: US 2003/0084190 A1
(43) Pub. Date: May 1, 2003

(54) Apparatus and system for maintaining accurate time in a wireless environment

(76) Inventor: Robert H. Kimball, La Jolla, CA (US)

Correspondence Address: QUALCOMM Incorporated, Attn: Patent Department, 5775 Morehouse Drive, San Diego, CA, 92121-1714, US

(21) Appl. No.: 10/061,523

(22) Filed: Oct. 25, 2001

(51) Int. Cl. G06F 15/16

(52) U.S. Cl. 709/248; 709/203

(57) ABSTRACT

According to a disclosed embodiment, a communication device comprises an air interface module which is synchronized in time with a universal time source such as Global Positioning System (“GPS”). The communication device further comprises a network time server which is synchronized with the universal time source. The communication device further comprises an address server configured to provide an address of the network time server to a CPU included in the communication device. The CPU is configured to synchronize time with the network time server and provide the synchronized time to a network interface. The network interface is configured to communicate the synchronized time to a user computer. For example, the user computer can run Network Time Protocol, NTP, to facilitate updating the system clock of the user computer using the synchronized time.

### BACKGROUND OF THE INVENTION

1. Field of the Invention

The present invention generally relates to the field of wireless communication systems. More specifically, the invention relates to providing accurate time information for Code Division Multiple Access communication systems.

2. Related Art

In wireless communication systems several users share a common communication channel. To avoid conflicts arising from several users transmitting information over the communication channel at the same time requires the use of some form of multiple access protocol, such as Code Division Multiple Access (“CDMA”). In addition to providing multiple access allocation to a channel of limited capacity, a protocol can serve other functions, for example, providing isolation of users from each other, i.e. limiting interference between users, and providing security by making interception and decoding difficult for a non-intended receiver, also referred to as low probability of intercept.

In CDMA systems each signal is separated from those of other users by coding the signal. Each user uniquely encodes its information signal into a transmission signal. The intended receiver, knowing the code sequences of the user, can decode the transmission signal to receive the information. The encoding of the information signal spreads its spectrum so that the bandwidth of the encoded transmission signal is much greater than the original bandwidth of the information signal. For this reason CDMA is also referred to as “spread spectrum” modulation or coding. The energy of each user's signal is spread across the channel bandwidth so that each user's signal appears as noise to the other users. So long as the decoding process can achieve an adequate signal to noise ratio, i.e. separation of the desired user's signal from the “noise” interference of the other users' signals, the information in the signal can be recovered.

Several different techniques and types of codes are used for encoding and decoding the information in transmission signals. For example, some commonly used techniques are interleaving of information symbols and repetition of information symbols. Some commonly used types of codes, also referred to as “spreading codes”, are Walsh functions (also referred to as “orthogonal spreading codes”) and pseudo-random noise codes, also called a PN (pseudo-noise) codes. In order to implement PN codes for use in a CDMA system, the pseudo-random code sequence, which determines the PN code, or the “PN code sequence”, can be accurately time-synchronized at the transmitter and receiver to enable the receiver to decode the transmission signal. For example, the IS-95A CDMA standard uses PN codes that are time-synchronized to midnight Jan. 6, 1980 using the time standard of the Global Positioning System (“GPS”). An information symbol in the transmission signal is decoded with the same code symbol in the PN code sequence, which was used to encode the symbol. Thus, one way of ensuring that the same code symbol from the PN code sequence that was used to code the symbol at the transmitter is also used at the receiver to decode the symbol is to accurately time-synchronize the PN code sequence used at the transmitter with the same PN code sequence used at the receiver. The time-synchronization of PN code sequences occurs in the “physical layer” of CDMA systems so that it is unknown or “transparent” to the user, and generally it is not made available for use by the consumer user of a CDMA system.

It often happens that a computer user would like to have accurate time information. For example, most personal computer systems are provided with a system clock, which is useful for time and date stamping of files, and for providing a clock display for the computer user's convenience. The system clock time is typically provided by a local clock internal to the personal computer (“PC”). When the accuracy of the local internal clock is not sufficient for the computer user's needs, the system clock can be updated from a more accurate external time source.

Referring now to FIG. 1, an example is illustrated of a method for providing time information from an external time source to a personal computer. FIG. 1 shows system 100 including a personal computer, PC 102, connected to the Internet, Internet 104, via connection 106 which may include, for example, a Local Area Network (“LAN”) using Ethernet, a modem, a Digital Subscriber Line (“DSL”), or other connection to an Internet service provider. System 100 also includes time server 108 connected to Internet 104. For example, time server 108 can be one of numerous servers in the Internet that are synchronized to Universal Time Coordinated (“UTC”) via radio, satellite or modem. UTC is the international time standard (formerly Greenwich Mean Time, or GMT). Zero hours UTC is midnight in Greenwich England, which is located at 0 degrees longitude. All locations east of Greenwich (up to 180 degrees) are later in time; all locations west of Greenwich are earlier. Time server 108 can be used to provide time information to update or synchronize the system clock of PC 102. For example, the computer user can run a software program known as Network Time Protocol (“NTP”) client. NTP is an Internet standard protocol used to synchronize the clocks of computers to some time reference. A similar protocol is SNTP (“Simple Network Time Protocol”) which is the same as NTP except that it lacks some internal algorithms that are not needed for all types of servers. Simply stated, NTP operates by periodically requesting time information from time server 108. The period between requests is variable and can be set by the computer user. For example, the computer user can set NTP to request a time update every 3 hours. NTP follows a protocol which performs various corrections, for example, a correction for the transmission delay of the time value can be made; in other words, the time value returned to the PC is corrected by taking into account the amount of time it takes for the time value to be sent from the time server to the PC. Thus, NTP can provide a time value which can be used to accurately reset the local internal system clock of PC 102 on a periodic basis.

Referring now to FIG. 2, another example is illustrated of a method for providing time information to a personal computer using a wireless communication system to communicate with an external time source. FIG. 2 shows system 200 including PC 202, connected to CDMA modem 204 via connection 206 which may include, for example, an Ethernet interface to a LAN connected to CDMA modem 204, or a universal serial bus (“USB”) interface connection to CDMA modem 204. CDMA modem 204 is part of a CDMA system, as described above, which communicates with base station 208 over wireless communication channel 210. Communication channel 210 can be, for example, radio frequency transmission between transmit and receive antennas in a CDMA wireless communication system.

Continuing with FIG. 2, base station 208 is connected to Internet 212, via connection 214 which may include, for example, a LAN using Ethernet, a modem, a DSL line, or other connection to an Internet service provider. System 200 includes time server 216 connected to Internet 212. Time server 216 can be used to provide time information to update the system clock of PC 202. For example, the computer user can run the NTP program described above. NTP can provide a time value which can be used to accurately reset the local internal system clock of PC 202 on a periodic basis as specified by the computer user.

As illustrated pictorially by the arrows marked “NTP” in FIGS. 1 and 2, the operation of the NTP program spans the entire breadth of both system 100 and system 200. In other words, NTP is running on a PC in each of FIGS. 1 and 2, and gathers time information from the time server in each of FIGS. 1 and 2 in order to perform NTP's function of accurately updating the local internal system clock of each PC. The time information must flow through every pictured element in each of systems 100 and 200 to get from the time server to the PC. As described above, one of the functions of NTP is to correct for the amount of time it takes for the time information to get from the time server to the PC. The longer the physical distance, the larger the correction must be. Large corrections are likely to be less accurate than small corrections. In addition, not only the physical distance, but the number of system elements the time information must pass through also contributes to delay. Moreover, it is relatively expensive to involve the wireless communication channel in transmission of the time information from the time server to the PC.

Thus, there is a need in the art for accurately resetting the local internal system clock of a computer by communicating with an external reliable time source. Moreover, there is a need in the art for inexpensively resetting the local internal system clock of a computer from an accurate external time source.

### SUMMARY OF THE INVENTION

The present invention is directed to apparatus and system for maintaining an accurate time in a wireless environment. The invention provides for accurately resetting the local internal system clock of a computer by communicating with an external reliable time source. Moreover, the invention resets the local internal system clock of a computer from an accurate external time source inexpensively by avoiding the use of unnecessary communication channel bandwidth and unnecessary Internet access.

According to the invention, a communication device comprises an air interface module which is synchronized in time with a universal time source such as Global Positioning System (“GPS”). For example, the air interface module can be part of a CDMA wireless communication system which uses GPS, for purposes of providing time synchronization for the CDMA system. The communication device further comprises a network time server which is synchronized with the universal time source. The communication device further comprises an address server configured to provide an address of the network time server to a CPU included in the communication device. For example, the address server can run Dynamic Host Configuration Protocol (“DHCP”) to provide an Internet Protocol (“IP”) address to the CPU. The CPU is configured to synchronize time with the network time server and provide the synchronized time to a network interface, which can be, for example an Ethernet interface, included in the communication device. The network interface is configured to communicate the synchronized time to a user computer. For example, the user computer can run Network Time Protocol, NTP, to facilitate updating the system clock of the user computer using the synchronized time.

### BRIEF DESCRIPTION OF THE DRAWINGS

FIG. 1 is a block diagram illustrating a known method for providing time information to a personal computer using an external time source.

FIG. 2 is a block diagram illustrating another known method for providing time information to a personal computer using a wireless communication system to communicate with an external time source.

FIG. 3 is a block diagram illustrating an example of providing accurate time information to a personal computer in accordance with one embodiment of the present invention in an exemplary wireless communication system.

FIG. 4 is a block diagram showing some of the features and components of a modem used for providing accurate time information to a personal computer in accordance with one embodiment of the present invention in an exemplary wireless communication system.

### DETAILED DESCRIPTION OF THE PREFERRED EMBODIMENTS

The presently disclosed embodiments are directed to apparatus and system for maintaining an accurate time in a wireless environment. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention. The specific details not described in the present application are within the knowledge of a person of ordinary skill in the art.

The drawings in the present application and their accompanying detailed description are directed to merely example embodiments of the invention. To maintain brevity, other embodiments of the invention which use the principles of the present invention are not specifically described in the present application and are not specifically illustrated by the present drawings.

Referring now to FIG. 3, an example of providing accurate time information from an external time source to a user computer, which is a personal computer, using a wireless communication system in accordance with one embodiment is illustrated. FIG. 3 shows exemplary system 300 including PC 302, connected to CDMA modem 304 via connection 306 which may include, for example, an Ethernet interface to a LAN connected to CDMA modem 304, a Universal Serial Bus (“USB”) interface connection to CDMA modem 304, or a Personal Computer Memory Card International Association (“PCMCIA” or PCCard) interface to CDMA modem 304. CDMA modem 304 communicates with base station 308 over wireless communication channel 310. Communication channel 310 can be, for example, radio frequency transmission between transmit and receive antennas in a CDMA wireless communication system, and CDMA modem 304 can be a High Data Rate (“HDR”) modem.

An HDR modem is capable of providing data transfer at a rate of approximately 2.4 million bits per second (“Mbps”) in a standard CDMA voice communication channel. For example, HDR technology can be implemented in an existing CDMA communication system by changing some of the channels from voice transmission to data transmission. Thus, CDMA modem 304, which may be an HDR modem, and base station 308 are included in a CDMA communication system.

The general principles of CDMA communication systems, and in particular the general principles for generation of spread spectrum signals for transmission over a communication channel is described in U.S. Pat. No. 4,901,307 entitled “Spread Spectrum Multiple Access Communication System Using Satellite or Terrestrial Repeaters” and assigned to the assignee of the present invention. The disclosure in that patent, i.e. U.S. Pat. No. 4,901,307, is hereby fully incorporated by reference into the present application. Moreover, U.S. Pat. No. 5,103,459 entitled “System and Method for Generating Signal Waveforms in a CDMA Cellular Telephone System” and assigned to the assignee of the present invention, discloses principles related to PN spreading, Walsh covering, and techniques to generate CDMA spread spectrum communication signals. The disclosure in that patent, i.e. U.S. Pat. No. 5,103,459, is also hereby fully incorporated by reference into the present application. Further, the present invention utilizes time multiplexing of data and various principles related to “high data rate” communication systems, and the present invention can be used in “high data rate” communication systems, such as that disclosed in U.S. patent application entitled “Method and Apparatus for High Rate Packet Data Transmission” Ser. No. 08/963,386 filed on Nov. 3, 1997, and assigned to the assignee of the present invention. The disclosure in that patent application is also hereby fully incorporated by reference into the present application.

Continuing with FIG. 3, base station 308 is in communication with a universal time source such as the Global Positioning System, GPS 318, for purposes of providing time synchronization for the CDMA system. For example, the time standard signal from GPS, also referred to as the “GPS time” or “GPS system time”, can be used by the CDMA system, which includes CDMA modem 304 and base station 308, for purposes of synchronizing the PN codes used for encoding and decoding the information in transmission signals, as described above.

The Global Positioning System (GPS), which is used solely as one example of a universal time source in the present exemplary embodiment, was developed by the U.S. military to supply position and time information for navigation all over the world. Currently the GPS system includes 24 satellites in orbit at approximately 11,000 nautical miles above the earth, in 12 hour orbits. Each satellite carries four atomic clocks for very high precision timing. Each satellite continuously broadcasts a digital radio signal that includes both its own position and the time, exact to a billionth of a second. The satellites are monitored and controlled from five terrestrial stations located in Colorado, Hawaii, Ascension Island, Kwajalein, and Diego Garcia. To maintain the specified accuracy, most of the satellites require daily updates of their data. The United States Air Force Consolidated Space Operations Center in Colorado transmits daily updates to each satellite, correcting their clocks and their orbital data. The GPS system time is referenced to the Master Clock (MC) at the United States Naval Observatory (“USNO”) and is steered to UTC time from which it, i.e. the GPS system time, will not deviate by more than one microsecond. As a result of the time synchronization of base station 308 with a universal time source such as GPS 318, CDMA modem 304 is time synchronized with a universal time source such as GPS 318.

CDMA modem 304 incorporates network time server 322. CDMA modem 304 is synchronized in time with the CDMA base station 308, which uses GPS as a universal time source. Network time server 322 has access to a universal time source, in the present example the GPS time, available from CDMA modem 304. Network time server 322 runs NTP (or SNTP). NTP is used to synchronize the time of a computer client or server to another server or reference time source. For example, NTP can be used to synchronize the time of a computer client, such as PC 302, to a server, such as network time server 322. In order to synchronize the time of a computer client or server to another server or reference time source, a distributed network clock synchronization protocol is required which can read a server clock, transmit the reading to one or more clients and adjust each client clock as required. Protocols that do this include the Network Time Protocol (NTP), Digital Time Synchronization Protocol (DTSS) and others. The synchronization protocol determines the time offset of the server clock relative to the client clock. The various synchronization protocols in use today provide different means to do this, but they all follow the same general model. On request, the server sends a message including its current clock value or “timestamp” and the client records its own timestamp upon arrival of the message. For the best accuracy, the client needs to measure the server-client propagation delay to determine its clock offset relative to the server. Since it is not possible to determine the one-way delays, unless the actual clock offset is known, the protocol measures the total roundtrip delay and assumes the propagation times are statistically equal in each direction. In general, this is a useful approximation; however, in the Internet, network paths and the associated delays can differ significantly due to the individual service providers. Thus, a local time server, such as network time server 322, provides an advantage in accuracy by not accessing the Internet.

Most computers include a quartz resonator-stabilized oscillator and hardware counter that interrupts the processor at intervals of a few milliseconds. At each interrupt, a quantity called “tick” is added to a system variable representing the clock time. The clock can be read by system and application programs and set on occasion to an external reference. Once set, the clock readings increment at a nominal rate, depending on the value of “tick”. Typical systems provide a programmable mechanism to increase or decrease the value of “tick” by a small, fixed amount in order to amortize a given time adjustment smoothly over multiple “tick” intervals. Thus, network time server 322 can be used to provide time information to update the system clock of PC 302. NTP can be used to provide a time value which can be used to accurately reset the local internal system clock of PC 302 on a periodic basis specified by the computer user. Network time server 322 provides time information based on a universal time source, such as the GPS time, to PC 302 without accessing a time server through wireless communication channel 310 and without the need to access the Internet.

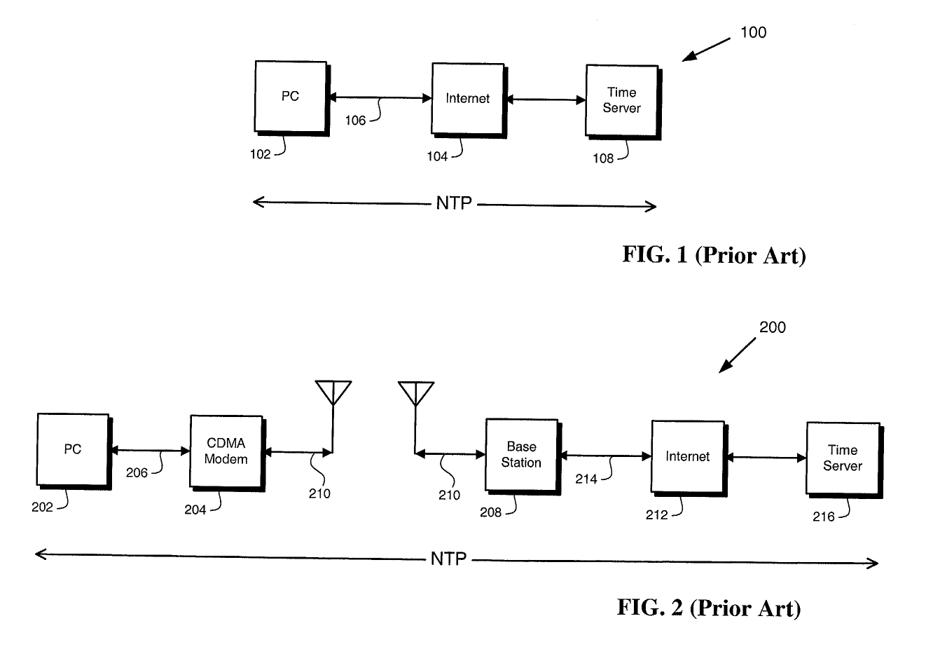

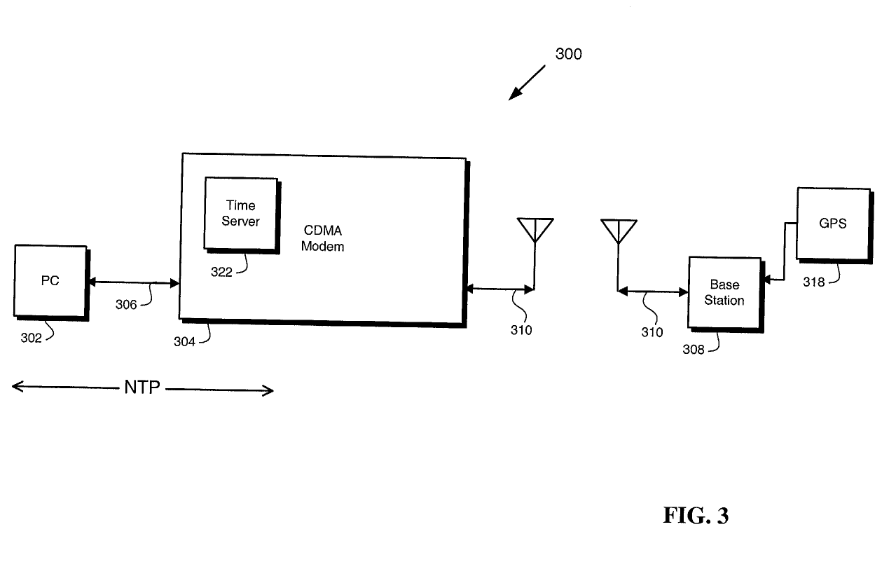

As illustrated pictorially by the arrows marked “NTP” in FIG. 3, and in contrast to the illustrations of FIGS. 1 and 2, the operation of the NTP program does not span the entire breadth of system 300. In other words, the time information gathered by NTP running on PC 302 need only pass locally from network time server 322 in CDMA modem 304 to PC 302. By way of contrast to the examples of FIGS. 1 and 2, network time server 322, shown in FIG. 3, makes use of a universal time source synchronization, for example the GPS time synchronization, locally available at CDMA modem 304. Thus, FIG. 3 illustrates a system, in accordance with one embodiment, which uses a wireless communication system to provide accurate time information from an external time source to a personal computer, and which reduces the delay and relative expense of providing the time information.

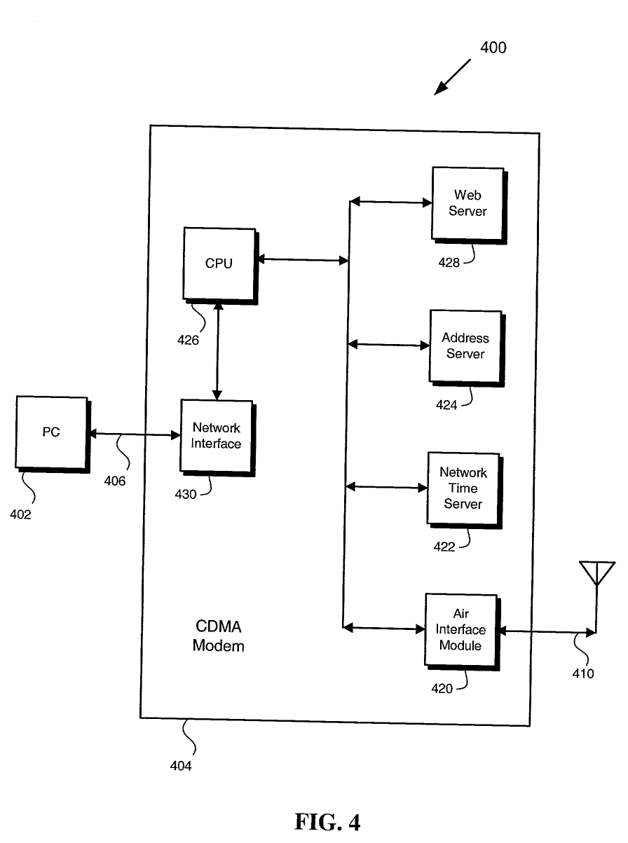

Referring now to FIG. 4, some of the features and components of a CDMA modem used for providing accurate time information from an external time source to a personal computer in a wireless communication system in accordance with one embodiment is illustrated. FIG. 4 shows exemplary system 400 including PC 402, connected to CDMA modem 404 via connection 406 which may include, for example, an Ethernet interface to a LAN connected to CDMA modem 404, a USB interface connection to CDMA modem 404, or a PCMCIA interface to CDMA modem 404. CDMA modem 404 communicates with a base station (not shown in FIG. 4) over wireless communication channel 410. Communication channel 410 can be, for example, radio frequency transmission between transmit and receive antennas in a CDMA wireless communication system. Thus, CDMA modem 404 is included in a CDMA communication system.

Continuing with FIG. 4, CDMA modem 404 comprises several modules including air interface module 420, network time server 422, address server 424, a central processing unit—CPU 426, Web server 428, and network interface 430. The flow of information between modules is indicated in the block diagram of FIG. 4 by the arrows between modules which also indicate the direction of information flow.

Air interface module 420 is configured to communicate with a GPS over a wireless communication channel. For example, air interface module 420 can be an HDR (high data rate) CDMA module which communicates with a base station (not shown in FIG. 4) which is in communication with a universal time source such as the Global Positioning System for purposes of providing time synchronization for the CDMA system. For example, the GPS time can be used by the CDMA system for purposes of synchronizing the PN codes used for encoding and decoding the information in transmission signals, as described above. The time-synchronization of the CDMA system can be used to make GPS time available for output from air interface module 420 to network time server 422.

Network time server 422 is configured to receive and store time from a universal time source such as the GPS time, from air interface module 420. Network time server 422 then makes time from a universal time source, such as the GPS time, available to other modules through software using a network time protocol. For example, SNTP (simple network time protocol) or NTP (network time protocol) can be used.

Address server 424 facilitates the communication of GPS time between network time server 422 and PC 402 by providing an IP (“Internet Protocol”) address of network time server 422 to CPU 426 for use by PC 402. Address server 424 can also perform a number of network related functions. For example, address server 424 can be used to run a Dynamic Host Configuration Protocol (“DHCP”). DHCP can be used to assign various network parameters to PC 402, for example, domain name, domain name server addresses, IP address of network time server 422, and IP address for Web server 428.

Web server 428 is configured to communicate with CPU 426, and thereby to PC 402. Any network device, such as CDMA modem 404, can contain an internal Web server (HTTP (“Hyper Text Transport Protocol”) server) as a means for configuring the device. For example, the computer user may use a Web browser to communicate from PC 402 to Web server 428 via the TCP/IP (“Transmission Control Protocol/Internet Protocol”) protocol. The browser sends HTTP requests to the server, which responds with HTML (“Hyper Text Markup Language”) pages and possibly additional programs in the form of ActiveX controls or Java applets.

The use of DHCP in conjunction with address server 424 and Web server 428 relieves the computer user from performance of tedious tasks. For example, when PC 402 is connected to CDMA modem 404, PC 402 “automatically knows” the IP address of network time server 422 so that resetting the local internal system clock of PC 402 is implemented so as to increase convenience for the computer user. Moreover, the user can easily reset optional parameters for NTP from a web page running on Web server 428.

CPU 426 is configured to receive time from a universal time source, such as the GPS time, from network time server 422 and to provide time from a universal time source, for example the GPS time, to network interface 430. In addition, CPU 426 mediates orderly communication among all the modules of CDMA modem 404 shown in FIG. 4. Network interface 430 is configured to communicate with CPU 426 and to communicate with PC 402 so that orderly communication is provided between CPU 426 and PC 402. For example, network interface 430 can be an Ethernet interface, or standard USB, or PCMCIA interface, or any other suitable interface for enabling communication between CDMA modem 404 and PC 402. Thus, FIG. 4 illustrates a system, in accordance with one embodiment, to provide accurate time information to a personal computer, and which reduces the delay and relative expense of providing the time information.

It is appreciated by the above description that the invention provides apparatus and system for maintaining an accurate time in a wireless environment. According to an embodiment of the invention described above, accurate time information is provided from an external time source to a computer using a wireless communication system. According to an embodiment, the physical distance over which time information must travel from a network time server to a computer is reduced, and the number of system elements the time information must pass through also is reduced. Therefore, accuracy can be improved for resetting the local internal system clock of a computer. Moreover, according to an embodiment of the invention described above, the wireless communication channel is no longer involved in transmission of time information from the network time server to the computer. Thus, an embodiment of the invention reduces the relative expense and CDMA communication channel bandwidth involved in providing time information for resetting the local internal system clock of a computer. Although the invention is described as applied to communications in a CDMA system, it will be readily apparent to a person of ordinary skill in the art how to apply the invention in similar situations where accurate resetting of the local internal system clock of a computer is needed where there is access to a wireless communication system.

From the above description, it is manifest that various techniques can be used for implementing the concepts of the present invention without departing from its scope. Moreover, while the invention has been described with specific reference to certain embodiments, a person of ordinary skill in the art would recognize that changes can be made in form and detail without departing from the spirit and the scope of the invention. For example, different network time protocols can be used for providing time information from a network time server to a computer. Also, for example, different address or configuration protocols other than the DHCP protocol described in connection with one embodiment can be used. The described embodiments are to be considered in all respects as illustrative and not restrictive. It should also be understood that the invention is not limited to the particular embodiments described herein, but is capable of many rearrangements, modifications, and substitutions without departing from the scope of the invention.

Thus, apparatus and system for maintaining an accurate time in a wireless environment have been described.

1. A communication device comprising:
an air interface module configured to communicate with a universal time source over a wireless communication channel;
a network time server configured to receive and store a universal time source time from said air interface module;
an address server configured to provide to a CPU of said communication device an address of said network time server;
said CPU configured to receive said universal time source time from said network time server and to provide said universal time source time to a network interface;
said network interface configured to communicate said universal time source time to a computer.

2. The communication device of claim 1 wherein said universal time source is a GPS and wherein said universal time source time is a GPS time.

3. The communication device of claim 2 wherein said air interface module is configured to communicate with said GPS through a base station in a CDMA wireless communication system.

4. The communication device of claim 2 wherein said communication device comprises an HDR CDMA modem.

5. The communication device of claim 2 wherein said address server provides said address of said network time server using DHCP.

6. The communication device of claim 2 wherein said network interface comprises an Ethernet interface.

7. The communication device of claim 2 wherein said network interface comprises a USB interface.

8. The communication device of claim 2 wherein said network interface comprises a PCMCIA interface.

9. The communication device of claim 2 further comprising a Web server configured to communicate with said CPU.

10. The communication device of claim 1 wherein said computer obtains said universal time source time from said network time server in said communication device by running NTP.

11. The communication device of claim 1 wherein said computer obtains said universal time source time from said network time server in said communication device by running SNTP.

12. The communication device of claim 2 wherein said computer obtains said GPS time from said network time server in said communication device by running NTP.

13. The communication device of claim 2 wherein said computer obtains said GPS time from said network time server in said communication device by running SNTP.

14. A system comprising:
a communication device comprising a network time server;
a wireless communication channel;
a base station in communication with a universal time source, said base station obtaining a universal time source time from said universal time source;
said base station providing said universal time source time to said communication device through said wireless communication channel;
said communication device supplying said universal time source time to a user computer.

15. The system of claim 14 wherein said universal time source is a GPS and wherein said universal time source time is a GPS time.

16. The system of claim 14 wherein said communication device comprises an HDR CDMA modem.

17. The system of claim 14 wherein said network time server runs a distributed network clock synchronization protocol to supply said universal time source time to said user computer

18. The system of claim 15 wherein said network time server runs a distributed network clock synchronization protocol to supply said GPS time to said user computer.

19. The system of claim 17 wherein said distributed network clock synchronization protocol is an NTP.

20. The system of claim 18 wherein said distributed network clock synchronization protocol is an NTP.

21. The system of claim 14 wherein said wireless communication channel comprises radio frequency transmission between transmit and receive antennas in a CDMA wireless communication system.

22. The system of claim 14 wherein said base station comprises a base station in a CDMA wireless communication system.

23. The system of claim 15 wherein said GPS time is referenced to UTC.

24. The system of claim 15 wherein said communication device supplies said GPS time via a network interface to said user computer.
